(19) United States
(12) Patent Application Publication
(10) Pub. No.: US 2008/0011795 A1
(43) Pub. Date: Jan. 17, 2008

(54) Bicycle transport rack

(76) Inventor: Tom C. Howorth, Aledo, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 11/820,567

(22) Filed: Jun. 20, 2007

Related U.S. Application Data
(60) Provisional application No. 60/831,163, filed on Jul. 13, 2006.

(51) Int. Cl. B60R 9/10

(52) U.S. Cl. 224/321

(57) ABSTRACT

A transport rack is shown for mounting a tandem bicycle on the rear of a vehicle. A junction bar is provided which engages the trailer hitch of the vehicle and is used to mount a cross bar on the vehicle. The cross bar supports the bicycle for transportation by having a fixed bicycle fork support yoke at one extent thereof and having both a slidably adjustable support yoke and slidably adjustable tire well at an opposite extent thereof. Wheel carriers located on the cross arm receive either one or both of the bicycle wheels when the wheels are removed for transport. A pivot mechanism connects the cross bar and junction bar and can be used to pivot the cross bar between an upright position, used for transport, in which the bicycle frame is generally perpendicular to a surrounding support surface and an extended position used for accessing to the vehicle's rear doors.

### CROSS REFERENCE TO RELATED APPLICATIONS

The present application claims priority from earlier filed provisional application Ser. No. 60/831,163, filed Jul. 13, 2006, entitled “Bicycle Transport Rack”.

### BACKGROUND OF THE INVENTION

1. Field of the Invention

The present invention relates generally to an apparatus and method for the mounting and carrying of extended frame bicycles at the rear of vehicles.

2. Description of the Prior Art

A number of “extended frame” bicycle designs are known. For example, two-seat, i.e., tandem bicycles, are designed to allow two persons to ride together. Such activities are often performed at a location requiring vehicular transport, be it for leisure or competition. The two bicyclists can respectively propel the tandem bicycles through a chain transmission mechanism. A typical tandem bicycle is comprised of a front bicycle unit and a rear cycle unit coupled together. As a result, the overall frame tends to be longer and occupy more space than a standard bicycle frame. Furthermore, most two-seat tandem bicycles are not collapsible, and therefore, even with one or both wheels removed from the central body, they require a large amount of storage space during transport. Even with the large cabin size of some transport vehicles, it is difficult to store a tandem bicycle in the interior of the vehicle, making it necessary to carry the bicycle on the exterior of the vehicle.

Apparatuses for attachment to vehicle hitches for the purpose of carrying many specific types of cargo, including bicycles, are known in the prior art. While these prior art devices serve their specific design functions, they have limitations to the application involving the transportation of extended frame bicycles.

There are several known rooftop racks and carriers which have been designed for either permanent or temporary mounting of bicycles, including extended frame bicycles. In addition to other challenges, rooftop carriers present an obstacle during loading and unloading. Due to the nature of the tandem bicycle, it is larger and therefore heavier and more cumbersome than a standard bicycle. The equipment must somehow be placed on top of the vehicle without damaging either the vehicle or the equipment. Yet, the reason the equipment is being placed on top of the vehicle is due to its large size and great bulk. Many motor vehicles have roofs that are unable to support loads of this nature or roofs that are difficult to reach and mount objects thereon due to their relative height compared to other vehicles. As a result, it is inconvenient to carry tandem bicycles on the roofs of such vehicles.

Additionally, rooftop carriers and bumper hitch carriers that put the weight above the vehicle also cause a problem in terms of the reduced vertical clearance of the vehicles. The reduced clearance may make it difficult to enter a parking garage, for example.

For the above reasons, rear transport racks have also been developed for bicycle transport. However, many vehicles, such as sports utility vehicles, various panel trucks, vans, etc., have rear doors that swing outwardly, i.e., rearwardly to the side or rearwardly to the top, from the vehicle. As a result of such rearwardly swinging doors, special attention is needed when mounting carriers or racks at the rear of the vehicle without making it difficult to utilize the rearwardly swinging doors. It is generally necessary to provide such devices with a pivot mechanism of some sort. The requirement of a pivot mechanism adds a degree of complexity to the task of designing an acceptable extended frame bicycle transport rack.

For the above reasons, there is a need in the art for improved mounting apparatus capable of carrying tandem bicycles. The apparatus must be relatively simple in design and economical to manufacture. It must be sturdy enough to support bicycle frames of the type under consideration, safely and securely, even when traveling at highway speeds. The preferred transport rack should allow either or both of the bicycle wheels to be removed and stored on the racks, depending on the rear surface of the vehicle on which the rack is mounted. In addition, an improved apparatus for use with vehicles having rearwardly swinging doors is needed.

The present invention, as described below, overcomes the problems described above and other problems which will become apparent to one skilled in the art from the detailed description below.

### SUMMARY OF THE INVENTION

It is accordingly the general object of the present invention to provide an apparatus to transport an extended frame bicycle at the rear of a vehicle. It is also necessary to overcome the above-described limitations and other problems associated with the prior art devices for providing an apparatus to transport extended frame bicycles.

The discussion which follows uses the term “extended frame bicycle.” The term “extended frame bicycle” should be taken to mean a tandem bicycle, a recumbent bicycle, or other bicycle types of similar design. The apparatus, or transport rack, is joined to the rear trailer hitch of the transport vehicle by a junction bar. Preferably, the junction bar is a square tubular junction bar that has an inner extent sized to be received by the trailer hitch. The junction bar extends outwardly from the trailer hitch in order to provide an adequate width between the vehicle and the mounted bicycle.

A pivot mechanism is located on the junction bar and is preferably co-linear with the trailer hitch. The pivot mechanism can effectively pivot the transport rack between an upright position in which the bicycle frame is generally perpendicular to its surroundings, and an extended position in which the bicycle frame is generally horizontal with respect to the surroundings. During loading and transportation, the pivot mechanism will generally remain in the upright position. The extended position allows access to a vehicle's rear upwardly or outwardly swinging doors.

The pivot mechanism is comprised of two parallel plates spaced apart which connect a segment arm with the junction bar. The plates have a first and second transverse set of holes which are aligned with a mating set of holes in the junction bar. The first set of transverse holes receive a pivot pin and the second set of transverse holes receive a lock pin. The pivot pin allows the cross bar to pivot between a first upright position for loading and transporting a bicycle and a second extended position as previously described. The lock pin is removable to allow the pivot mechanism to pivot from the upright to the extended positions. When the locking pin is inserted within the respective set of transverse holes and locked, the pivot mechanism has substantially lost all freedom of rotation about its axis. However, when the locking pin is removed, the pivot mechanism has a 90° freedom of rotation about its axis. The removal of the pin allows for the transport rack to rotate 90° downward to provide the user easy access to the cargo area of the vehicle.

A segment arm extends at a convenient angle, generally at about a 45° angle from the junction bar and is sandwiched between the parallel plates of the pivot mechanism at one point along its length. The end of the segment arm opposite the junction bar is connected to the approximate midpoint of a cross bar.

The cross bar has a fixed bicycle fork support yoke at one extent thereof and both a slidably adjustable support yoke and slidably adjustable tire well at an opposite extent thereof. The slidably adjustable tire well is an angle bracket which has an upwardly facing opening sized for holding a bicycle tire on the cross bar. In addition, the cross bar has a slidably adjustable front wheel carrier arm located between the slidably adjustable support yoke and the fixed bicycle fork support yoke. The slidably adjustable front wheel carrier arm extends perpendicularly upwards and is capable of holding the front tire once it has been removed from the body of the bicycle.

The fixed bicycle fork support yoke is used to latch the forks of the bicycle once the front wheel has been removed, thus providing a stable point of contact for the bicycle on the transport rack. The slidably adjustable support yoke also has a rear wheel carrier arm extending perpendicularly upward in order to carry the rear wheel if the rear wheel has been optionally removed from the body of the bicycle. If the transport vehicle is smaller in size, the user might desire the removal of the rear wheel in order to lessen the length of the bicycle and therefore provide a more compact assembly of the bicycle on the transport rack.

In addition, the front wheel carrier arm can be slid along the cross bar and effectively tuck the wheel behind the vehicle to limit the transport rack's overall aerial exposure around the sides of the transport vehicle. In the event that the rear wheel is removed, the slidably adjustable support yoke will cradle the boom tube of the bicycle and carry the removed rear wheel with the extended rear wheel carrier arm connected to the support yoke. In this case, an adjustable belt will fasten the boom tube of the bicycle to the support yoke thereby limiting the mobility of the bicycle frame. However, if the rear wheel remains connected to the body of the bicycle, the wheel itself will rest in the slidably adjustable tire well. The slidably adjustable tire well also includes a constraint element in the form of an adjustable belt in order to fasten the rear wheel in close contact with the cross bar during transport, and thus limit the mobility of the wheel.

Additional objects, features and advantages will be apparent in the written description which follows.

### BRIEF DESCRIPTION OF THE DRAWINGS

FIG. 1 is a perspective view of a bicycle transport rack, according to the present invention, mounted at the rear of a vehicle and shown in a traveling position carrying a tandem bicycle with its front wheel removed.

FIG. 2 is a view similar to FIG. 1, with the transport rack shown in a traveling position carrying a tandem bicycle with its front and back wheels removed.

FIG. 3 is an isolated view of a bicycle transport rack of the invention, mounted at the rear of the vehicle and shown in the upright, movement of the slidably adjustable support yoke being indicated by the phantom lines.

FIG. 4 is another view of the bicycle transport rack of the invention shown in the extended position with the pivot mechanism fully extended and with a tandem bicycle shown in phantom lines.

### DETAILED DESCRIPTION OF THE INVENTION

The embodiments herein and the various features and advantageous details thereof are explained more fully with reference to the non-limiting embodiments that are illustrated in the accompanying drawings and detailed in the following description. Descriptions of well-known components and processes and manufacturing techniques are omitted so as to not unnecessarily obscure the embodiments herein. The examples used herein are intended merely to facilitate an understanding of ways in which the invention herein may be practiced and to further enable those of skill in the art to practice the embodiments herein. Accordingly, the examples should not be construed as limiting the scope of the claimed invention.

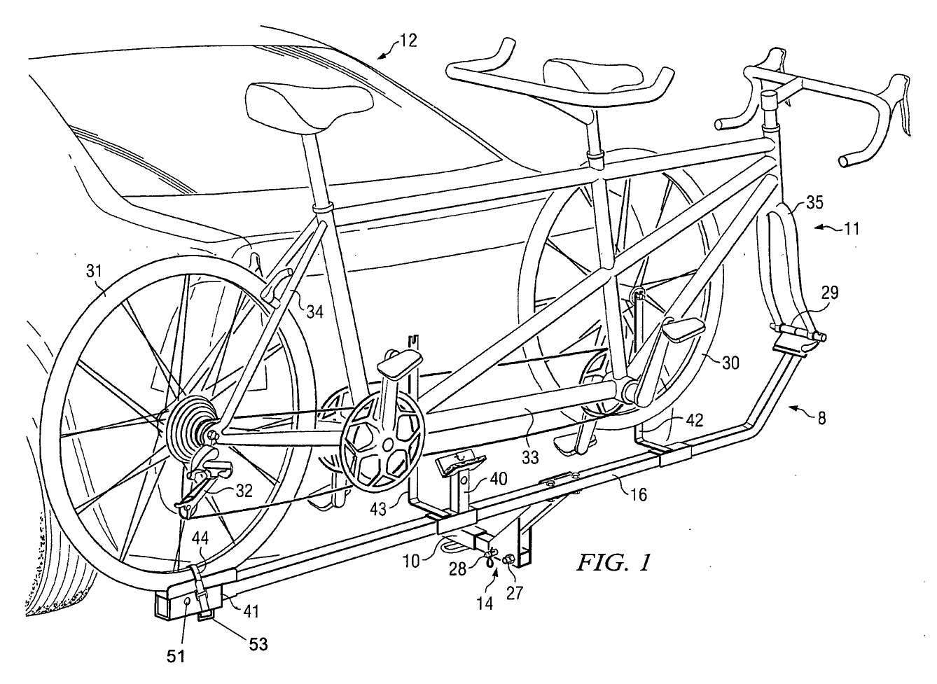

The present invention shall first be described with reference to FIGS. 1-4 illustrating a transport rack 8 for mounting an extended frame bicycle 11 on a trailer hitch 10 of a vehicle 12. The drawing FIGS. 1-4 are intended to illustrate the general environment of the present invention. Although the apparatus is shown being used to transport a tandem bicycle 11 at the rear of the vehicle 12, it should be noted that this particular invention may also be used to transport other types of extended frame bicycles, such as recumbent bicycles. The operation of the apparatus will still perform as described herein, with the user generally needing only to make minor adjustments to the slidably adjustable elements of the transport rack in order to fit the appropriate length of the particular bicycle under consideration, as will be explained later. For simplicity, in FIGS. 1, 2 and 4, a tandem bicycle 11 is used to illustrate the operations of the transport rack 8. For the purposes of the present invention, the tandem bicycle 11 is comprised at least of a front wheel 30 and rear wheel 31, a rear derailleur 32, a boom tube 33, a seat stay 34, and front bicycle forks 35.

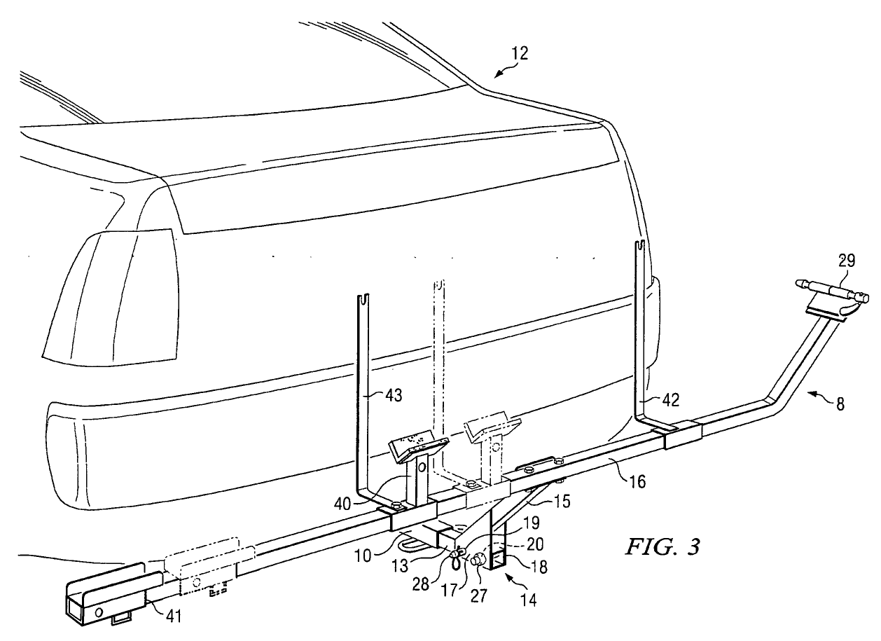

The various components that make up the transport rack 8 are perhaps best appreciated with reference to FIG. 3. As shown in FIG. 3, the transport rack includes a junction bar 13 having an inner extent sized to be received within the trailer hitch 10 and having an opposite extent connecting to a pivot mechanism 14 that is located generally co-linear with the trailer hitch 10. The hitch 10 and junction bar 13, in the embodiment of the invention illustrated in FIG. 3, are tubular, square cross-section members, preferably formed of a suitable metal such as iron, steel, aluminum or suitable alloy. For example, the hitch 10 could be a square tubular hitch such as the Reese Hitch™ manufactured by Reese International, 47774 Anchor Court West, Plymouth, Mich. 48170.

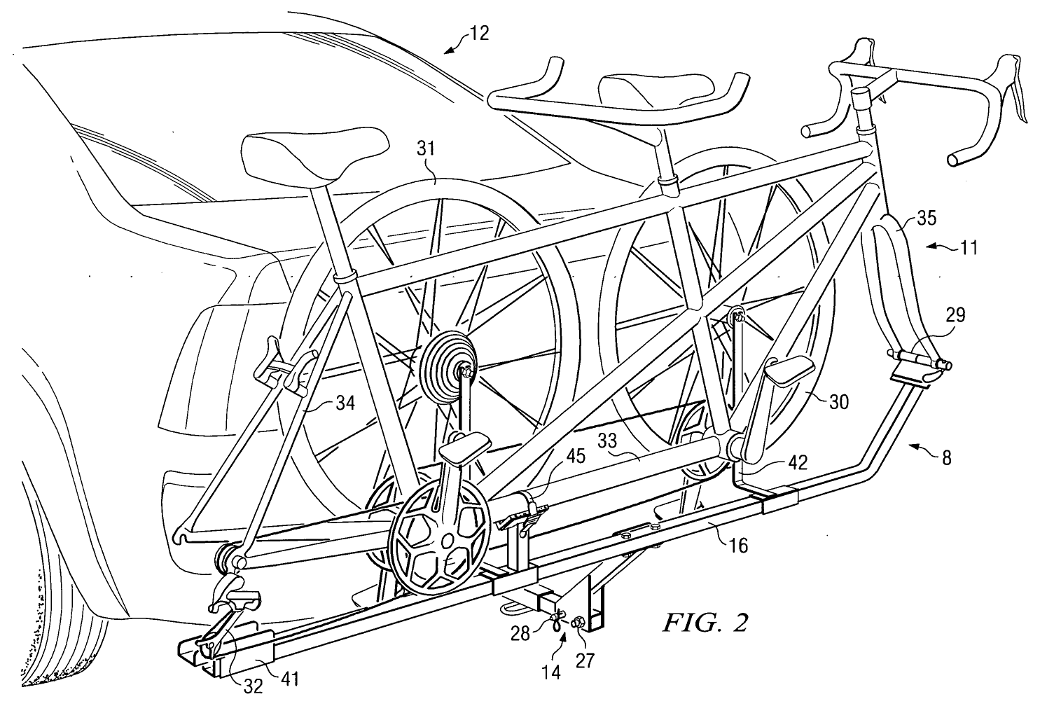

The junction bar 13 should be long enough to provide an adequate width between the transport rack and the rear of the vehicle. The width should render enough space to store either one or both of the removed wheels (30, 31 in FIG. 2) of the bicycle between the frame of the bicycle and the rear of the vehicle. By allowing this space, the removed wheels as well as the bicycle frame itself cannot cause damage by coming into physical contact with the rear of the vehicle while loading, unloading or transporting the bicycle.

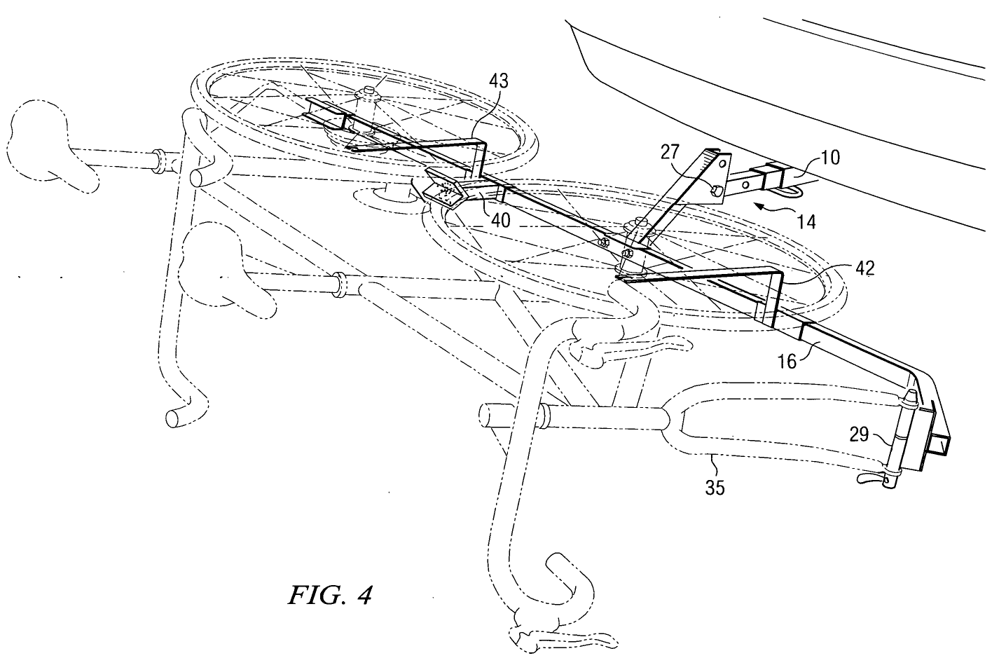

A segment arm 15, also of tubular metal construction, is connected to the junction bar 13 at an end and to the approximate midpoint of a cross bar 16. The junction bar 13 is sandwiched between the parallel plates 17,18 of the pivot mechanism at one point along its length. The end of the segment arm 15 opposite the junction bar 13 is connected to the approximate midpoint of the cross bar 16. The pivot mechanism 14 is used to effectively pivot the cross bar 16 between an upright position in which the bicycle frame mounted on the transport rack is generally perpendicular to a surrounding support surface, as shown in FIGS. 1 and 2, and an extended position in which the bicycle frame mounted on the transport rack is generally horizontal with respect to the support surface, as shown in FIG. 4. During transportation, the pivot mechanism 14 will remain in the upright position, shown in FIGS. 1 and 2. When the pivot mechanism is in its extended position, as shown in FIG. 4, the tandem bicycle is closely parallel to the surrounding support surface, allowing the user to access the vehicle's rear upwardly or outwardly swinging doors while the transport rack is in its extended position.

The pivot mechanism 14 is comprised of two parallel plates 17,18 which straddle the segment arm 15, at one point along its length and which also straddle the junction bar 13. The plates 17,18 have a first and second transverse set of holes 19,20 which are aligned with a mating set of holes in the junction bar (not shown). The first set of transverse holes 19 receive a locking pin 28 and the second set of transverse holes 20 receive a pivot pin 27. The pivot pin 27 allows the cross bar 16 to pivot between the first upright position, as shown in FIGS. 1, 2 and 3, for transporting the bicycle and the second extended position, as shown in FIG. 4. The locking pin 28 is removable to allow the pivot mechanism 14 to pivot from the upright to the extended positions.

When the locking pin 28 is inserted through the transverse holes 19 and locked, the pivot mechanism 14 has substantially lost all freedom of rotation about its axis. However, when the locking pin 28 is removed, the pivot mechanism 14 has a 90° freedom of rotation about its axis. The removal of the pin allows for the cross bar 16 to rotate 90° downward and provide the user with access to the rear door of the vehicle. FIGS. 1, 2, and 3 depict the transport rack with the locking pin 28 inserted through the transverse holes 19 for transportation purposes, whereas FIG. 4 is shown with the locking pin 28 removed and thus the pivot mechanism is fully extended.

The segment arm 15 extends at a convenient angle to provide adequate space between the transport rack and the rear of the vehicle. Preferably, the segment arm extends generally at a 45° angle from the pivot mechanism 14 and connects to the approximate midpoint of a cross bar 16.

FIG. 3 is intended to illustrate a load-less transport rack in the upright position. The cross bar 16 forms the base of the transport rack, in which the bicycle can be mounted for vehicular transport. The cross bar 16 has a fixed bicycle fork support yoke 29 at one extent thereof and both a slidably adjustable support yoke 40 and slidably adjustable rear tire well 41 at an opposite extent thereof. The slidably adjustable tire well element 41 is an angle bracket which has an upwardly facing opening sized for holding the tire portion of the rear bicycle wheel 31 on the cross bar 16. A set screw 51 fixes the tire well element 41 in the desired position. A strap loop 53 helps to secure the rear tire of the bicycle by means of the adjustable belt 44.

In addition, the cross bar 16 has a slidably adjustable front wheel carrier arm 42 located between the fixed bicycle fork support yoke and slidably adjustable support yoke. The slidably adjustable front wheel carrier arm 42 extends perpendicularly upwards and is capable of holding the front wheel 30 once it has been removed from the body of the bicycle. The fixed bicycle fork support yoke 29 is used to latch the forks 35 (FIGS. 1 and 2) of the bicycle once the front wheel 30 has been removed, thus providing a stable point of contact for the bicycle on the transport rack. The slidably adjustable yoke 40 also has mounted thereon a rear wheel carrier arm 43 extending perpendicularly upward in order to carry the rear wheel 31 if the rear wheel has been optionally removed from the body of the bicycle. Both the front and rear wheel carrier arms 42,43 are angled brackets having upper recesses for receiving a wheel axle of a front or rear bicycle wheel respectively. The carrier arms are both slidable along the length of the cross bar 16 by adjustment of a wing-nut, or the like. For example, FIG. 3 shows the rear wheel carrier arm and its associated yoke 40 in two different positions on the cross bar 16. The front and rear wheel carrier arms 42, 43 are interiorly angled to place the carrier arms between the bicycle frame and the rear of the transport vehicle.

The operation of the transport rack of the invention will now be briefly described. The transport rack 11 of the invention provides the option of removing and storing one or both bicycle wheels, depending primarily upon the nature of the transport vehicle being utilized. If the transport vehicle 12 is smaller in size, the user might desire the removal of both the front wheel 30 and of the rear wheel 31 in order to lessen the length of the bicycle and therefore provide a more compact assembly of the bicycle on the transport rack. If size is a concern, the front wheel carrier arm 42 can be slid inwardly along the cross bar 16 and effectively tuck the wheel behind the vehicle in order to limit the transport rack's overall aerial exposure around the sides of the transport vehicle. In the event that the rear wheel 31 is removed, as shown in FIG. 2, the slidably adjustable yoke 40 will cradle the boom tube 33 of the bicycle and carry the removed rear wheel 31 with the extended arm 43 connected to the yoke 40. The slidably adjustable yoke will include a constraint element in the form of an adjustable belt 45 in order to fasten the boom tube in close contact with the support yoke during transport and limit the mobility of the bicycle frame. However, if the rear wheel 31 remains connected to the body of the bicycle, as shown in FIG. 1, the wheel itself will rest in the slidably adjustable rear tire well 41. The slidably adjustable rear tire well 41 will include a constraint element in the form of an adjustable belt 44 in order to fasten the rear wheel 31 in close contact with the cross bar 16 during transport, and thus limit the mobility of the wheel.

As mentioned earlier, the present invention also accommodates the transport of other types of extended frame bicycles. In the case of a slightly different sized extended frame bicycle, all operations of the transport rack remain the same. However, in the case that the rear wheel is not removed from the body, the user will need to adjust the slidable rear tire well in order to fit the appropriate length of the bicycle. Conversely, if the rear tire is removed, the user will need to adjust both the slidable rear tire well and slidable support yoke to accommodate the bicycle's boom tube.

An invention has been provided with several advantages. The bicycle transport rack of the invention is simple in design and economical to manufacture. The transport rack is made of readily available materials and components and is of extremely sturdy design. The transport rack has special features which are especially directed toward the transport of extended frame bicycles, such as tandem bicycles.

In addition to providing the user a comfortable loading and unloading process, the pivot mechanism 14 of the transport rack provides an alternative access to vehicles that posses rear doors that swing outwardly, either rearwardly to the side or rearwardly to the top. In order to access the rear outwardly swinging doors, the user need only to remove the locking pin 28 and lower the pivot mechanism 14, without the necessity of removing the bicycle from the transport rack altogether.

While the invention has been shown in only one of its forms, it is not thus limited but is susceptible to various changes and modifications without departing from the spirit thereof.

What is claimed is:

1. A transport rack for mounting an extended frame bicycle on a trailer hitch of a vehicle, comprising:
a cross bar having a bicycle fork support yoke and slidably adjustable front wheel carrier arm at one extent thereof and having a slidably adjustable support yoke and slidably adjustable tire well at an opposite extent thereof;
a junction bar having an inner extent sized to be received within the trailer hitch and having an opposite extent;
a pivot mechanism located on the junction bar co-linear with the trailer hitch;
a segment arm connecting the pivot mechanism to the cross bar at an approximate mid point thereof;
the pivot mechanism being effective to pivot this transport rack between an upright position in which the bicycle frame is generally perpendicular to a surrounding support surface and an extended position in which the bicycle frame is generally horizontal with respect to the support surface.

2. The transport rack of claim 1, wherein the extended frame bicycle is a tandem bicycle.

3. A transport rack for mounting a tandem frame bicycle having front and rear wheels on a trailer hitch of a vehicle, comprising:
a cross bar having a bicycle fork support yoke and slidably adjustable front wheel carrier arm at one extent thereof which allows storage of the front bicycle wheel, and having a slidably adjustable support yoke and slidably adjustable tire well at an opposite extent thereof;
a rear wheel carrier arm dependent from and movable with the slidably adjustable support yoke for optionally allowing removal and storage of the rear bicycle wheel thereby providing a more compact assembly of the bicycle on the transport rack;
a junction bar having an inner extent sized to be received within the trailer hitch and having an opposite extent;
a pivot mechanism located on the junction bar co-linear with the trailer hitch;
a segment arm connecting the pivot mechanism to the cross bar at an approximate midpoint thereof;
the pivot mechanism being effective to pivot this transport rack between an upright position in which the bicycle frame is generally perpendicular to a surrounding support surface and an extended position in which the bicycle frame is generally horizontal with respect to the support surface.

4. The transport rack claim 3, wherein the slidably adjustable tire well element is an angle bracket which has an upwardly facing opening sized for holding a bicycle tire on the cross bar.

5. The transport rack of claim 4, wherein the pivot mechanism is comprised of two parallel plates which connect the segment arm and junction bar, the plates having a first and second transverse set of holes which are aligned with a mating set of holes in the junction bar, the first set of transverse holes receiving a pivot pin and the second set of transverse holes receiving a lock pin.

6. The transport rack of claim 5, wherein the pivot pin allows the cross bar to pivot between a first upright position for transporting a bicycle and a second extended position.

7. The transport rack of claim 6, wherein the lock pin is removable to allow the pivot mechanism to pivot from the upright to the extended positions.

8. The transport rack of claim 7, wherein the front and rear wheel carrier arms are angled brackets having upper recesses for receiving a wheel axle of a front or rear bicycle wheel respectively.

9. The transport rack of claim 8, wherein the junction bar is a generally square tubular member having an inner extent which is sized to be received within a square trailer hitch of the transport vehicle.

10. A method of mounting a tandem frame bicycle having front wheel forks and front and rear wheels, on a trailer hitch of a vehicle, the method comprising the steps of:
providing a transport rack having a cross bar with a fork support yoke and slidably adjustable front wheel carrier arm at one extent thereof which allows storage of the front bicycle wheel, and having a slidably adjustable support yoke and slidably adjustable tire well at an opposite extent thereof;
locating a rear wheel carrier arm dependent from and movable with the slidably adjustable support yoke for optionally allowing removal and storage of the rear bicycle wheel and thereby provide a more compact assembly of the bicycle on the transport rack.
providing a junction bar having an inner extent sized to be received within the trailer hitch and having an opposite extent;
providing a pivot mechanism located on the junction bar co-linear with the trailer hitch;
providing a segment arm connecting the pivot mechanism to the cross bar at an approximate midpoint thereof;
mounting a tandem bicycle on the transport rack by removing the front wheel and mounting the bicycle front wheel forks on the front fork support yoke, the front wheel being mounted on the front wheel carrier arm, the bicycle rear wheel being mounted in the slidably adjustable tire well, whereby the bicycle is supported in an upright position in the transport rack from the rear of the vehicle.

11. The method of claim 10, wherein the pivot mechanism is used to pivot the transport rack between the upright position in which the bicycle frame is generally perpendicular to a surrounding support surface and an extended position in which the bicycle frame is generally horizontal with respect to the support surface.

12. The method of claim 10, wherein the transport rack is also provided with a slidably adjustable rear wheel carrier arm and both the front and rear wheels are removed from the bicycle and mounted on the transport rack.
